(19) United States
(12) Patent Application Publication
(10) Pub. No.: US 2015/0371440 A1
(43) Pub. Date: Dec. 24, 2015

(54) ZERO-BASELINE 3D MAP INITIALIZATION

(71) Applicant: QUALCOMM Incorporated, San Diego, CA (US)

(72) Inventors: Christian Pirchheim, Graz (AT); Jonathan Ventura, Colorado Springs, CO (US); Dieter Schmalstieg, Graz (AT); Clemens Arth, Judendorf-Strassengel (AT); Vincent Lepetit, Graz (AT)

(21) Appl. No.: 14/743,990

(22) Filed: Jun. 18, 2015

Related U.S. Application Data
(60) Provisional application No. 62/014,685, filed on Jun. 19, 2014.

(51) Int. Cl. G06T 17/05; G06T 7/00

(52) U.S. Cl. CPC G06T 17/05; G06T 7/0075; G06T 7/0046; G06T 2200/04; G06T 2207/10012; G06T 2207/10032

(57) ABSTRACT

A computer-implemented method, apparatus, computer readable medium and mobile device for initializing a 3-Dimensional (3D) map may include obtaining, from a camera, a single image of an urban outdoor scene and estimating an initial pose of the camera. An untextured model of a geographic region may be obtained. Line features from the single image may be extracted and the orientation may be determined with respect to the untextured model and using the extracted line features, the orientation of the camera in 3 Degrees of Freedom (3DOF). In response to determining the orientation of the camera, a translation in 3DOF with respect to the untextured model may be determined using the extracted line features. The 3D map may be initialized based on the determined orientation and translation.

### CROSS-REFERENCE TO RELATED APPLICATION

This application claims the benefit of priority from U.S. Provisional Application No. 62/014,685, filed Jun. 19, 2014, entitled, “INITIALIZATION OF 3D SLAM MAPS” which is herein incorporated by reference.

### TECHNICAL FIELD

This disclosure relates generally to computer vision based 6D pose estimation and 3D registration applications, and in particular but not exclusively, relates to initialization of a 3-Dimensional (3D) map.

### BACKGROUND INFORMATION

A wide range of electronic devices, including mobile wireless communication devices, personal digital assistants (PDAs), laptop computers, desktop computers, digital cameras, digital recording devices, and the like, employ machine vision techniques to provide versatile imaging capabilities. These capabilities may include functions that assist users in recognizing landmarks, identifying friends and/or strangers, and a variety of other tasks.

Recently, augmented reality (AR) systems have turned to model-based tracking algorithms or Simultaneous Localization And Mapping (SLAM) algorithms that are based on color or grayscale image data captured by a camera. SLAM algorithms reconstruct three-dimensional (3D) points from incoming image sequences captured by a camera and are used to build a 3D map of a scene (i.e., a SLAM map) in real-time. From the reconstructed map, it is possible to localize a camera's 6DOF (Degree of Freedom) pose in a current image frame.

However, initialization of 3D feature maps with monocular SLAM is difficult to achieve in certain scenarios. For example, outdoor environments may have too small a baseline and/or depth ratios for initializing the SLAM algorithms. Additionally, SLAM only provides relative poses in an arbitrary referential with unknown scale, which may not be sufficient for AR systems such as navigation or labeling of landmarks. Existing methods to align the local referential of a SLAM map with the global referential of a 3D map with metric scale have required the user to wait until the SLAM system has acquired a sufficient number of images to initialize the 3D map. The waiting required for initialization is not ideal for real-time interactive AR applications. Furthermore, certain AR systems require specific technical movements of the camera to acquire a series of images before the SLAM map can be accurately initialized to start tracking the camera pose.

### BRIEF SUMMARY

Some embodiments discussed herein provide for improved initialization of a 3D mapping system using a single acquired image. As used herein, this may be referred to as a zero-baseline 3D map initialization where no movement of the camera is necessary to begin tracking of the camera pose.

In one aspect, a computer-implemented method of initializing a 3-Dimensional (3D) map includes: obtaining, from a camera, a single image of an urban outdoor scene; estimating, from one or more device sensors, an initial pose of the camera; obtaining, based at least in part on the estimated initial pose, an untextured model of a geographic region that includes the urban outdoor scene; extracting a plurality of line features from the single image; determining, with respect to the untextured model and using the extracted line features, the orientation of the camera in 3 Degrees of Freedom (3DOF); determining, in response to determining the orientation of the camera, a translation in 3DOF with respect to the untextured model and using the extracted line features; and initializing the 3D map based on the determined orientation and translation.

In another aspect, a computer-readable medium includes program code stored thereon for initializing a 3D map. The program code includes instructions to: obtain, from a camera, a single image of an urban outdoor scene; estimate, from one or more device sensors, an initial pose of the camera; obtain, based at least in part on the estimated initial pose, an untextured model of a geographic region that includes the urban outdoor scene; extract a plurality of line features from the single image; determine, with respect to the untextured model and using the extracted line features, the orientation of the camera in 3DOF; determine, in response to determining the orientation of the camera, a translation in 3DOF with respect to the untextured model and using the extracted line features; and initialize the 3D map based on the determined orientation and translation.

In yet another aspect, a mobile device includes memory coupled to a processing unit. The memory is adapted to store program code for initializing a 3D map and the processing unit is configured to access and execute instructions included in the program code. When the instructions are executed by the processing unit, the processing unit directs the apparatus to: obtain, from a camera, a single image of an urban outdoor scene; estimate, from one or more device sensors, an initial pose of the camera; obtain, based at least in part on the estimated initial pose, an untextured model of a geographic region that includes the urban outdoor scene; extract a plurality of line features from the single image; determine, with respect to the untextured model and using the extracted line features, the orientation of the camera in 3DOF; determine, in response to determining the orientation of the camera, a translation in 3DOF with respect to the untextured model and using the extracted line features; and initialize the 3D map based on the determined orientation and translation.

In a further aspect, an apparatus includes: means for obtaining, from a camera, a single image of an urban outdoor scene; means for estimating, from one or more device sensors, an initial pose of the camera; means for obtaining, based at least in part on the estimated initial pose, an untextured model of a geographic region that includes the urban outdoor scene; means for extracting a plurality of line features from the single image; means for determining, with respect to the untextured model and using the extracted line features, the orientation of the camera in 3DOF; means for determining, in response to determining the orientation of the camera, a translation in 3DOF with respect to the untextured model and using the extracted line features; and means for initializing the 3D map based on the determined orientation and translation.

The above and other aspects, objects, and features of the present disclosure will become apparent from the following description of various embodiments, given in conjunction with the accompanying drawings and appendices.

### BRIEF DESCRIPTION OF THE DRAWINGS

FIG. 1A illustrates an operating environment for initializing a 3D map, in one embodiment;

FIG. 1B illustrates a topographical map to initialize a 3D map, in one embodiment;

FIG. 1C illustrates a representation of the real world environment with highlighted environment aspects, in one embodiment;

FIG. 1D illustrates a representation of the real world environment with augmented reality graphical elements, in one embodiment;

FIG. 1E is a flowchart illustrating a process of initializing a 3D map using a single image, in one embodiment;

FIG. 2 is a flowchart illustrating a process of initializing a 3D map using a single image, in another embodiment;

FIG. 3 is a functional block diagram of a processing unit to perform 3D map initialization from a single image, in one embodiment;

FIG. 4 is a functional block diagram of an exemplary mobile device capable of performing the processes discussed herein; and

FIG. 5 is a functional block diagram of an image processing system, in one embodiment.

### DETAILED DESCRIPTION

Reference throughout this specification to “one embodiment”, “an embodiment”, “one example”, or “an example” means that a particular feature, structure, or characteristic described in connection with the embodiment or example is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Any example or embodiment described herein is not to be construed as preferred or advantageous over other examples or embodiments.

In one embodiment, a zero-baseline (3D) map initialization (ZBMI) method or apparatus enables auto-localization on a mobile device from a single image of the environment. ZBMI can compute the position and location of the mobile device in an environment/world from the single image and from data from one or more mobile device sensors/receivers (e.g., Satellite Positioning Systems (SPS), magnetometer, gyroscope, accelerometer, or others). Image and sensor data may be retrieved and processed at the mobile device (e.g., by ZBMI). Image and sensor data may be processed with a 2D map and building height data. For example, a 2D floor plan or city map. In one embodiment, ZBMI refines the image, sensor data, and map data to output a 6DOF pose of the mobile device, which may be used to initialize a 3D map, such as the 3D map in a SLAM system.

In one embodiment, ZBMI provides more accurate 6DOF localization from initialization of the SLAM system (e.g., from the first keyframe) and improved usability over a traditional SLAM system without ZBMI. For example, usability considerably improved for panoramic camera motion, which commonly occurs in real world/typical usage such as for AR systems implemented by a mobile device. ZBMI can produce a globally accurate 6DOF pose for 3D map initialization (e.g., SLAM or other tracking and mapping system) starting with the first captured image. Estimated camera trajectory is considerably smoother than other techniques, because the 3D locations of feature points may be constrained through projection onto façades of the mobile devices surrounding environment.

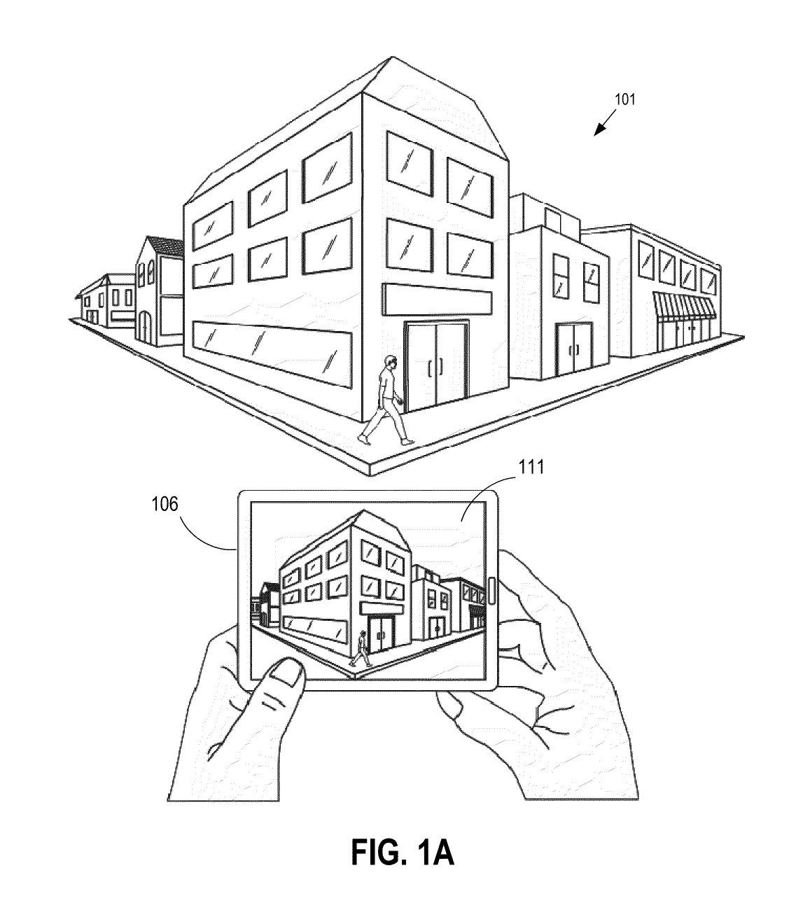

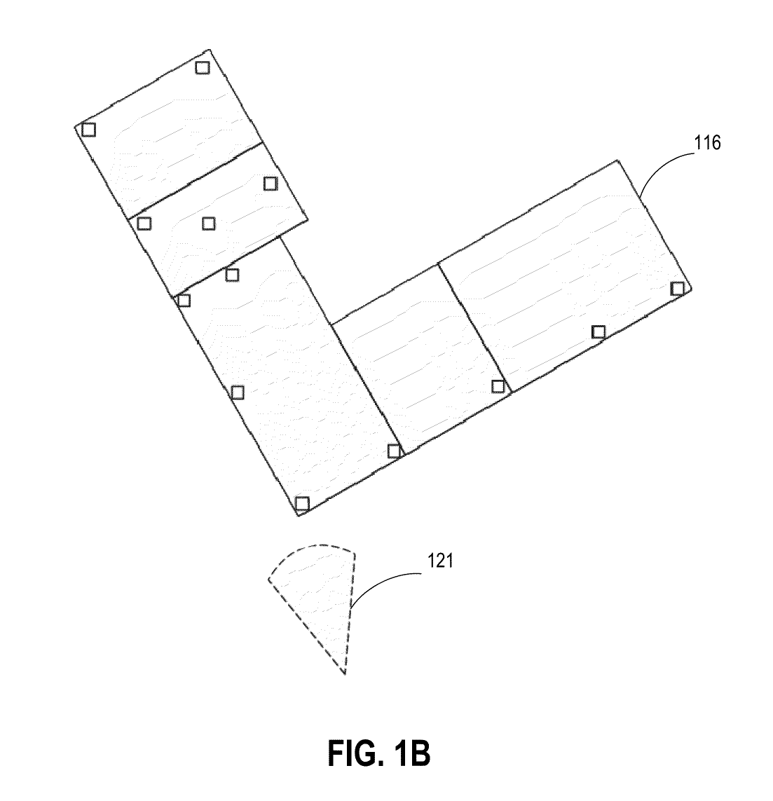

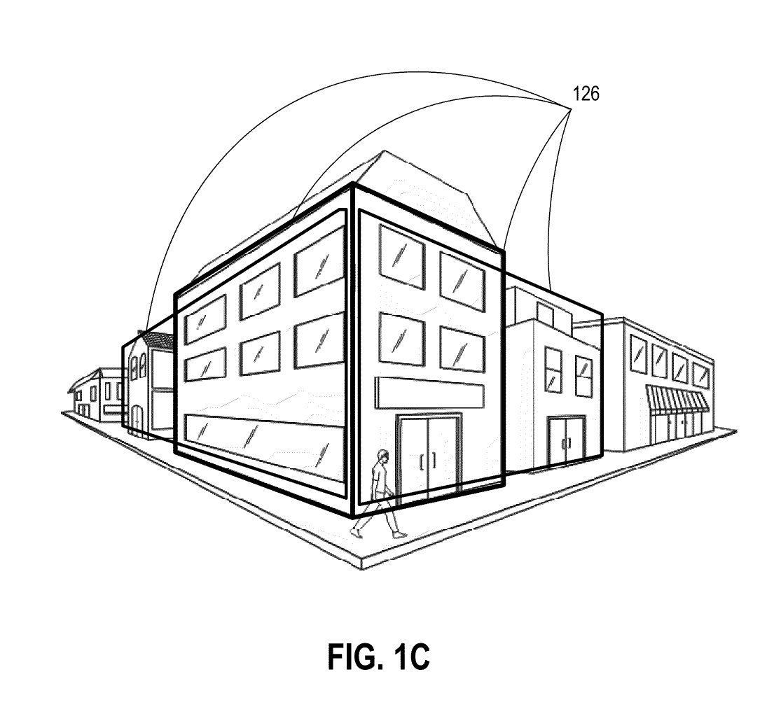

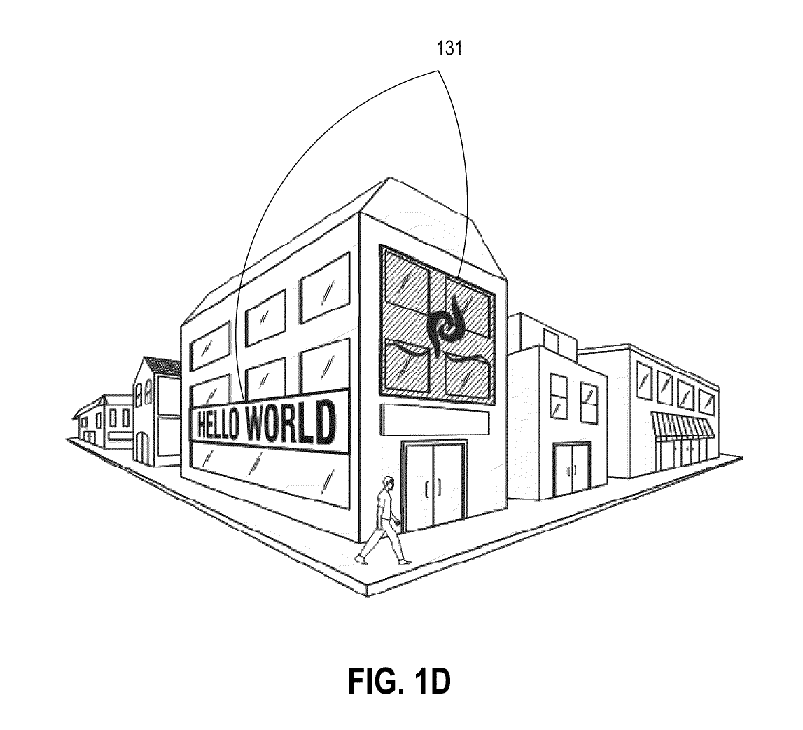

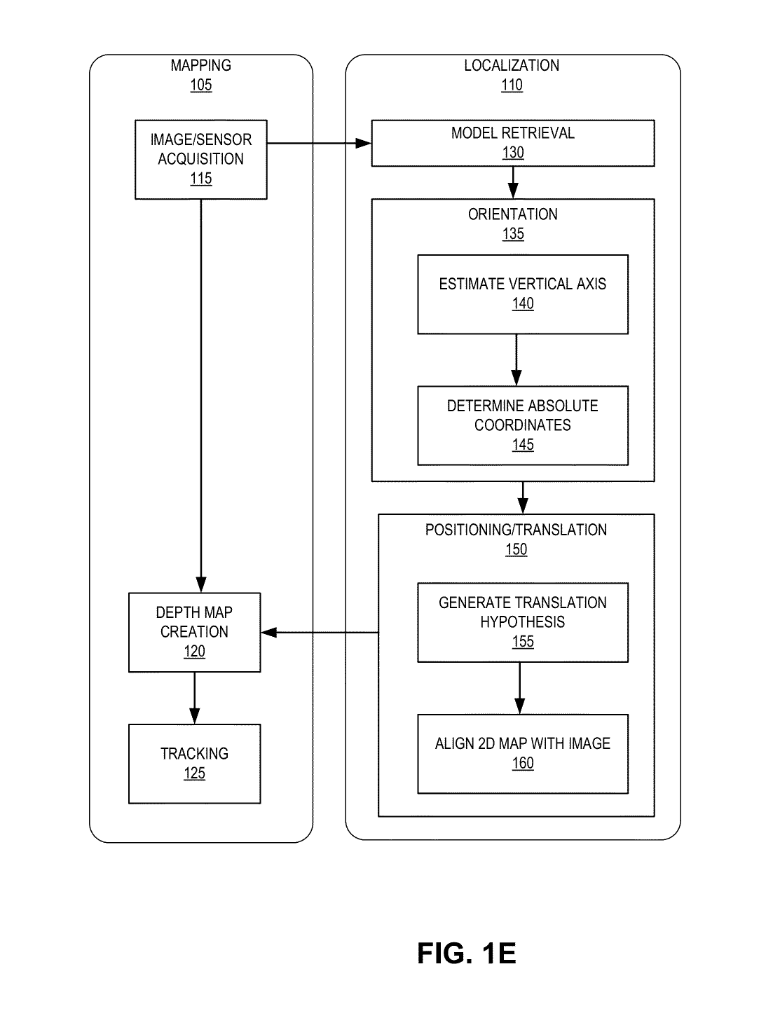

FIG. 1A illustrates an operating environment for initializing a 3D map, in one embodiment. Scene 101 represents an urban outdoor scene from the viewpoint of mobile device 106. In some embodiments, the mobile device 106 may display a representation of the urban outdoor scene. For example, the mobile device may display a real time view 111 that may include graphical overlays or information related to the scene.

FIG. 1B illustrates a topographical map to initialize a 3D map, in one embodiment. For example, the topographical map may be a untextured 2D map 116 with building height data (i.e., a 2.5D map). In some embodiments, the untextured 2D map includes a 2D city map with building façade outlines. Each building façade may have an attached/associated height value. Mobile device 106 may record a single image and an initial sensor 6D pose 121 with respect to 2D map 116. Using computer vision techniques, a refined 6D pose 122 may be computed.

FIG. 1C illustrates a representation of the real world environment with highlighted environment aspects, in one embodiment. Embodiments described herein may reproject a globally aligned building model 126 into the image using a sensor pose. The reprojection may be corrected using techniques described herein.

FIG. 1D illustrates a representation of the real world environment with augmented reality elements, in one embodiment. Augmented reality elements 131 (i.e., virtual elements) may vary according to the particular implementation. For example, elements 131 may be advertisements, information overlays (e.g., tourist information, assisted direction for maps, store/restaurant reviews, etc.), game components, or many other augmented reality implementations.

FIG. 1E is a flowchart illustrating a process 100 for performing ZBMI, in one embodiment. As introduced above, ZBMI can provide for instant geo-localization of a video stream (e.g., from a first image captured by a mobile device). ZBMI can register the first image from the video stream to an untextured 2.5D map (e.g., 2D building footprints and approximate building height). In one embodiment, ZBMI estimates the absolute camera orientation from straight-line segments (e.g., block 135) and then estimates the camera translation/position by segmenting the façades in the input image and matching them with those of the 2.5D map (e.g., at block 150). The resulting pose is suitable to initialize a 3D map (e.g., a SLAM or other mapping and tracking system). For example, a 3D map may be initialized by back-projecting the feature points onto synthetic depth images rendered from the augmented 2.5D map.

At block 105, the embodiment (e.g., ZBMI) performs mapping of an environment. The mapping may be SLAM or another mapping process. During the process of mapping the environment, an image may be acquired at block 115 for use in localization 110, and depth map creation 120. A tracking and mapping system (e.g., SLAM) for indoor use may rely on depth sensors for increased robustness and instant initialization. However, depth sensors may not be as useful in an outdoor environment. In some embodiments, ZBMI may leverage the 2.5D map to generate synthetic depth images as a cue for tracking and mapping. In some embodiments, ZBMI utilizes a keyframe-based SLAM system (e.g., a system such as PTAM (Parallel Tracking and Mapping) or other similar system). The tracking and the mapping thread may run asynchronously and periodically exchange keyframe and map information. ZBMI can register a first keyframe to the 2.5D map, and use the pose estimate to render a polygonal model. ZBMI may use a graphics hardware to retrieve the depth buffer and assign depth to map points (e.g., map points which correspond to observed façades). ZBMI may determine a full 3D map from the first keyframe, unlike traditional methods requiring an established baseline of several meters between a first two keyframes for initial triangulation. As the mapping system (e.g., SLAM) acquired additional keyframes, the process above is repeated, and tracked map points collect multiple observations for real triangulation once the baseline between keyframes is sufficient. ZBMI can also track the environment (e.g., block 125) determined from the image acquisition from block 115 and depth map created at block 120.

At block 110, ZBMI Localization uses the image acquired at block 115 to retrieve model data, and determine orientation and translation to output a refined final pose using computer vision. At block 130, ZBMI Localization may obtain an image and a coarse initial pose estimate from mobile sensors (e.g., camera, SPS, magnetometer, gyroscope, accelerometer, or other sensors). For example, the image and initial sensor pose may be determined from a keyframe acquired with a mapping system at block 115 (e.g., SLAM) running on a mobile device. From the sensor data, the coarse initial pose estimate (e.g., also referred to herein as a first 6DOF pose) is compiled, using the fused compass and accelerometer input to provide a full 3×3 rotation matrix with respect to north/east and the earth center and augmenting it with the SPS (e.g., WGS84 GPS) information in metric UTM4 coordinates to create a 3×4 pose matrix. ZBMI may also retrieve a 2.5D map containing the surrounding buildings (e.g., 2D map with building height data). In one embodiment, 2D and building height data may be retrieved from a source such as OpenStreetMap® or other map data. In some embodiments, ZBMI may extrude 2D maps of surroundings from a map dataset with a course estimate of the height of the building façades. For example, OpenStreetMap® data consists of oriented line strips, which may be converted into a triangle mesh including face normal. Each building façade plane may be modeled as 2D quad with four vertices, two ground plane vertices and two roof vertices. The heights of the vertices may be taken from a source such as aerial laser scan data. Vertical building outlines may be aligned to a global vertical up-vector.

ZBMI may assume image line segments extracted from the visible building façades are either horizontal or vertical line segments. Extracted horizontal and vertical line assumptions are typically used in vanishing point and relative orientation estimation (e.g., for applications within urban environments). ZBMI can use the line assumptions to solve 2D-3D line correspondence problems (e.g., to determine the 6DOF pose with three correct image-model correspondences).

ZBMI may be implemented with a minimum amount of globally available input information, such as a 2D map and some building height information (e.g., a 2.5D untextured map). ZBMI may also utilize more detailed and accurate models and semantic information for enhanced results. For example, within an AR system synergies can be exploited for annotated content to be visualized which may be used as feedback into the ZBMI localization approach above to improve localization performance. For example, using the AR annotations of windows or doors can be used in connection to the ZBMI window detector to add another semantic class to the scoring function. Therefore, certain AR content might itself be used to improve localization performance within a ZBMI framework.

At block 135, ZBMI estimates the global camera orientation (e.g., with a single correspondence between a horizontal image line and a model façade plane). In some embodiments, the global camera orientation may be determined robustly by using minimal solvers in a Random Sample Consensus (RANSAC) framework. In one embodiment, ZBMI begins orientation estimation at block 140 by computing the pitch and roll of the camera (i.e., orientation of the camera's vertical axis with respect to gravity, from line segments). This can be performed without using any information from the 2.5D map. The estimation of the yaw, the remaining degree-of-freedom of the rotation, in the absolute referential of the 3D map may be less explored.

ZBMI estimates a rotation matrix Rᵥ that aligns the camera's vertical axis with the gravity vector. ZBMI may determine the dominant vertical vanishing point in the image, using line segments extracted from the image. ZBMI may utilize the Line Segment Detector (LSD) algorithm, followed by filtering. In one embodiment, ZBMI includes filters to: 1) retain line segments exceeding a certain length, 2) remove lines below the horizon line computed from the rotation estimate of the sensor (i.e., segments likely located on the ground plane or foreground object clutter), 3) remove line segments if the angle between their projection and the gravity vector given by the sensor is larger than a configurable threshold, or any filter combination thereof. In other embodiments, additional or different filters may be implemented.

The intersection of point p of the projections l1 and l2 of two vertical lines is the vertical vanishing point. The vertical vanishing point may be computed as a cross product using homogeneous coordinates:

p=l₁×l₂ Eq. 1

ZBMI may search pairs of lines to find the dominant vanishing point. For each pair of vertical line segments, ZBMI can compute the intersection point and test against all line segments, for example by using an angular error measure:

$$err ( p , l ) = a cos ( \frac{p \cdot l}{‖ p ‖ \cdot ‖ l ‖} ) \qquad Eq . 2$$

The dominant vertical vanishing point pᵥ is chosen as the one with the highest number of inliers using an error threshold (e.g., a number of degrees), which may be evaluated in a RANSAC framework.

Given the dominant vertical vanishing point pᵥ, ZBMI can compute the rotation which aligns the camera's vertical axis with the vertical vanishing point of the 2.5D map. The vertical direction of the 2.5D map is assumed z=[0 0 1]^{T}. Using angle-axis representation, the axis of the rotation is u=pᵥ x z and the θ is acos(pᵥ)(z), assuming that the vertical vanishing point is normalized. The rotation Rᵥ then can be constructed using SO(3) exponentiation:

$${R}_{v} = {exp}_{SO ( 3 )} ( u \cdot \frac{θ}{‖ u ‖} ) \qquad Eq . 3$$

In response to determining the camera orientation up to a rotation around its vertical axis (yaw), ZBMI at block 145 estimates the last degree of freedom for the orientation. ZBMI can estimate the camera rotation around the vertical axis in the absolute coordinate system by constructing a façade model. The façade model may be determined by extruding building footprints from the 2.5D map as upright rectangular polygons. The line segments corresponding to horizontal edges to a model may be rotated by h and back-projected to the façade model. The optimal h makes the back-projections appear as horizontal as possible. Given a polygon f from the façade model, its horizontal vanishing point is found as the cross product of its normal n_{f} and the vertical axis z:

pₕ=n_{f}×z Eq. 4

After orientation correction through Rᵥ, the projection of horizontal lines lying on f should intersect pₕ. Thus, given a horizontal vanishing point pₕ and the projection of a horizontal line segment l₃, ZBMI can compute the rotation Rₕ about the vertical axis to align the camera's horizontal axis with the horizontal vanishing point of f. This rotation has one degree of freedom, φ_{z}, the amount of rotation about the vertical axis:

$${R}_{h} = [ \begin{matrix}cos {∅}_{z} & - sin {∅}_{z} & 0 \\ sin {∅}_{z} & cos {∅}_{z} & 0 \\ 0 & 0 & 1\end{matrix} ] \qquad Eq . 5$$

Using the substitution

$$q = tan \frac{{∅}_{z}}{2}$$

results in

$$cos {∅}_{z} = \frac{1 - {q}^{2}}{1 + {q}^{2}}$$

and

$$sin {∅}_{z} = \frac{2 q}{1 + {q}^{2}} .$$

Parameterizing the rotation matrix in terms of q:

$${R}_{h} = \frac{1}{1 + {q}^{2}} [ \begin{matrix}1 - {q}^{2} & - 2 q & 0 \\ 2 q & 1 - {q}^{2} & 0 \\ 0 & 0 & 1 + {q}^{2}\end{matrix} ] \qquad Eq . 6$$

The intersection constraint between l3 and the horizontal vanishing point pₕ is expressed as:

pₕ(Rₕl₃)=0 Eq. 7

The roots of this quadratic polynomial in q determine two possible rotations. This ambiguity is resolved by choosing the rotation which best aligns the camera's view vector to the inverse normal −n f. Finally, the absolute rotation R of the camera is computed by chaining the two previous rotations Rᵥ and Rₕ:

R=RᵥRₕ Eq. 8

In one embodiment, ZBMI creates pairs <l, f > from line segments “l” assigned to visible façades “f,” identified from the 2.5D map using the initial pose estimate from the sensors. ZBMI can use a Binary Space Partition (BSP) tree for efficient search the 2.5D map for visible façades. As used herein, a BSP tree is a data structure from Computer Graphics to efficiently solve visibility problems. ZBMI can evaluate the angular error measure from Eq. 2 for a rotation estimate from the pair <l, f> in a RANSAC framework, choosing the hypothesis with the highest number of inliers.

In some embodiments, ZBMI considers the following degenerate case of: <l, f> pairs where l is actually located on a perpendicular façade plane f⊥, resulting in rotation hypotheses R which are 90 degrees off the ground truth. Given a visible façade set where all façades are pairwise perpendicular, such a rotation hypothesis may receive the highest number of inliers. ZBMI can discard such <l, f> pairs by computing the angular difference between the sensor pose and the rotation hypothesis R and discard the hypothesis if it exceeds a threshold of 45 degrees. The case of <l, f> pairs where l is actually located on a parallel façade, f_{∥} should not cause any problems because in this case f_{∥} and f have the same horizontal vanishing point ph.

At block 150, ZBMI performs translation estimation (e.g., estimation of the global 3D camera position) by utilizing two correspondences between vertical image lines and model façade outlines. For example, ZBMI may first extract potential vertical façade outlines in the image and match them with corresponding model façade outlines, resulting in a sparse set of 3D location hypothesis. To improve the detection of potential vertical façade outlines in the image, ZBMI may first apply a multi-scape window detector before extracting the dominant vertical lines. ZBMI can verity the set of pose hypothesis with an objective function to score the match between a semantic segmentation of the input image and the reprojection of the 2.5D façade model. The semantic segmentation may be computed with a fast light-weight multi-class support vector machine. The resulting global 6DOF keyframe pose together with the retrieved 2.5D model is used by the mapping system (e.g., a SLAM system) to initialize its 3D map. ZBMI may render a depth map and assign depth values to 2.5D keyframe features and thus initialize a 3D feature map. This procedure may be repeated for subsequent keyframes to extend the 3D map, allowing for absolute 6DOF tracking or arbitrary camera motion in a global referential.

In one embodiment, the vertical and horizontal segments on the façades allow ZBMI to estimate the camera's orientation in a global coordinate frame. However, the segments may not provide a useful constraint to estimate the translation when their exact 3D location is unknown. Theoretically, the pose may be computed from correspondences between the edges of the buildings in the 2.5D map and their reprojections in the images. However, such matches may be difficult to obtain reliably in absence of additional information. In one embodiment, ZBMI aligns the 2.5D map with a semantic segmentation of the image to estimate the translation of the camera as the one that aligns the façades of the 2.5D map with the façades extracted from the image. To speed up this alignment, and to enhance reliability, ZBMI may first generate a small set of possible translation hypotheses given the line segments in the image that potentially correspond to the edges of the buildings in the 2.5D map. For example, the actual number of hypothesis K may depend on the number of detected vertical image lines M and model façade outlines N: K←2*nchoosek(N, 2)*nchoosek(M, 2). In some embodiments, the number of hypothesis K ranges between 2 and 500, however other ranges are also possible. ZBMI may then keep the hypotheses that best aligns the 2.5D map with the segmentation.

At block 155, ZBMI generates translation hypothesis. In one embodiment, ZBMI initializes translation hypothesis by setting an estimated camera height above the ground to compensate for potential pedestrian occlusion of the bottom of buildings. For example, ZBMI may adjust vertical axis to a height of a mobile device when handheld by an average user (e.g., 1.6 meters or some other configurable height). ZBMI can generate possible horizontal translations for the camera by matching the edges of the buildings with the image.

In one embodiment, ZBMI translation hypothesis also includes generating a set of possible image locations for the edges of the buildings with a heuristic. For example, ZBMI may first rectify the input image using the orientation so that vertical 3D lines also appear vertical in the image, and then sums the image gradients along each column. The columns with a large sum are likely corresponding to the border of a building. However, since windows also have strong vertical edges, erroneous hypotheses may be generated. To reduce the influence of erroneous hypothesis, ZBMI may incorporate a multi-scale window detector. Pixels lying on the windows found by the multi-scale window detector may be ignored when computing the gradient sums over the columns ZBMI may also use a façade segmentation result to consider only the pixels that lie on façades, but not on windows. Since the sums may take very different values for different scenes, ZBMI can use a threshold estimated automatically for each image. ZBMI may fit a Gamma distribution to the histogram of the sums and evaluate the quantile function with a fixed inlier probability. Lastly, ZBMI may generate translation hypotheses for each possible pair of correspondences between the vertical lines extracted from the image and the building corners. The building corners come from the corners in the 2.5D maps that are likely to be visible, given the location provided by the GPS and the orientation estimated during the first step, again using the BSP tree for efficient retrieval. Given two vertical lines in the image, l₁ and l₂, and two 3D points which are the corresponding building corners, x₁ and x₂, the camera translation t in the ground plane can be computed by solving the following linear system:

$$\{ \begin{matrix}{I}_{1} \cdot ( {x}_{1} + t ) = 0 \\ {I}_{2} \cdot ( {x}_{2} + t ) = 0\end{matrix} \qquad Eq . 9$$

In one embodiment, ZBMI translation hypothesis further includes filtering the hypotheses set based on their estimated 3D location. In one embodiment, ZBMI filtering includes discarding hypotheses which have a location outside of a threshold GPS error range. For example, ZBMI may define a sphere whose radius is determined by an assumed GPS error (e.g., 12.5 meters or some other configurable or retrieved error value/threshold) are discarded. In one embodiment, ZBMI filtering may remove hypotheses which are located within buildings.

In one embodiment ZBMI processes much more complex scenes beyond scenes having typical cube buildings. For example, some traditional methods are not fully automatic because they use manually annotated input images to facilitate the detection of vertical facade outlines. However, utilizing annotated input images can be cumbersome and impractical compared to the process described herein. For example, as described above, ZBMI utilizes a robust method for orientation estimation, and can consider a large number of potential vertical building outlines. The resulting pose hypotheses are verified based on a semantic segmentation of the image, which adds another layer of information to the pose estimation process. This allows ZBMI to be applied to images with more complex objects/buildings compared to other methods (e.g., methods which are limited to free-standing “cube” buildings).

At block 160 ZBMI aligns the 2.5D map with the image. To select the best translation among the translation hypotheses generated using the process described above. ZBMI may evaluate the alignment of the image and the 2.5D map after projection using each generated translation. ZBMI may use a simple pixel-wise segmentation of the input image, for example by applying a classifier to each image patch of a given size to assign a class label to the center location of the patch. The segmentation may use a multi-class Support Vector Machine (SVM), trained on a dataset of manually segmented images from a different source than the one used in ZBMI configuration testing and evaluation. In one embodiment, ZBMI uses integral features and considers five different classes C={c_{f}, cₛ, cᵣ, cᵥ, c_{g}} for façade, sky, roof, vegetation and ground, respectively. In other embodiments the amount and type of classes considered may be different than for this illustrative example. ZBMI may apply the classifier exhaustively to obtain a probability estimate p for each image pixel over the classes. Given the 2D projection Proj(M, p) of a 2D map+height M into the image using pose hypothesis p, the log-likelihood of the pose may be computed by:

sₚ=Σᵢ^{Proj(M,p)} log pᵢ(c_{f})+Σᵢ^{Proj(M,p)} log(1−pᵢ(c_{f})) Eq. 10

Proj(M, p) denotes the set of pixels lying outside the reprojection Proj(M, p). The pixels lying on the projection Proj(M, p) of the façades should have a high probability to be on a façade in the image, and the pixels lying outside should have a high probability to not be on a façade. ZBMI may keep the pose \hat{p} that maximizes the log-likelihood:

$$\hat{p} = {arg max }_{p} {s}_{p} \qquad Eq . 11$$

In some cases, the 3D location estimated from the sensors may not be accurate enough to directly initialize ZBMI. Therefore, ZBMI may sample additional initial locations around the sensor pose (e.g., six additional initial locations around the sensor pose in a hexagonal layout, or some other layout and number of locations), and combine the locations with the previously estimated orientation. ZBMI may initialize from each of these seven poses, searching within a sphere having configurable radius (e.g., 12.5 meters or other size) for each initial pose. ZBMI may then keep the computed pose with the largest likelihood. This approach may be extended for use with more complex building models, for example, such as models with roofs or other structural details in the model. The log-likelihood then becomes:

$${s}_{p} = {\sum }_{c ∈ {C}_{M}}^{ } {\sum }_{i}^{Proj ( {M}_{c} , p )} log {p}_{i} ( c ) + {\sum }_{i}^{Proj ( M , p )} log ( 1 - {\sum }_{c ∈ {C}_{M}}^{ } {p}_{i} ( c ) ) \qquad Eq . 12$$

where C_{M} is a subset of C and made of different classes that can appear in the buildings model, and Proj(M_{c}, p) is the projection of the components of the buildings model for class c. In some embodiments, other models may be used.

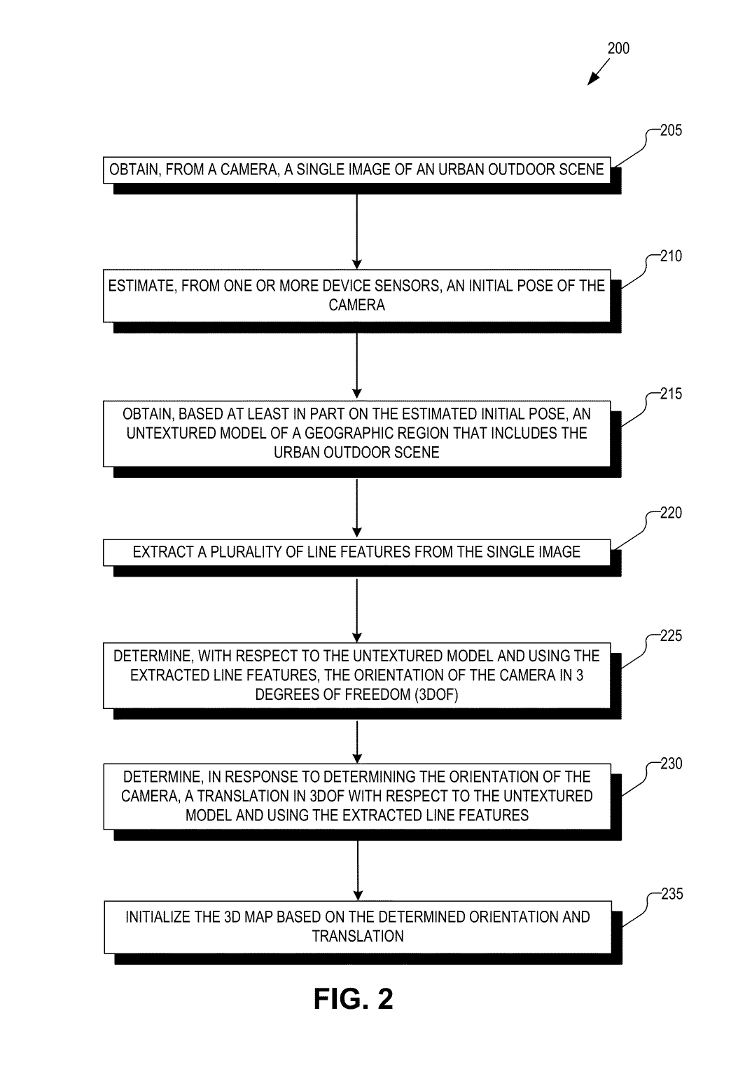

FIG. 2 is a flowchart illustrating a process 200 of initializing a 3D map from a single image, in another embodiment. At block 205 the embodiment (e.g., ZBMI) obtains, from a camera, a single image of an urban outdoor scene. For example, the camera may be an camera coupled to a mobile device (e.g., mobile device 106).

At block 210, the embodiment estimates, from one or more device sensors, an initial pose of the camera (e.g., the coarse initial pose estimate from mobile sensors introduced above).

At block 215, the embodiment obtains, based at least in part on the estimated initial pose, an untextured model of a geographic region that includes the urban outdoor scene. The untextured model may include a 2.5D topographical map with building height data. An untextured model may be a (2D, 3D, 2.5D) model that only contains geometric features (vertices) but no appearance (texture) information. In particular, ZBMI utilizes 2.5D models which include a 2D topological map (e.g., a 2D city map), where each geometric vertex in the (x,y) plane has a height value annotation, which is the z-coordinate. In some embodiments, the untextured model includes a 2D city map consisting of building façade outlines and each building façade has an attached height value.

At block 220, the embodiment extracts a plurality of line features from the single image. In some embodiments, extracted line features include line segments which are filtered according to one or more of: length, relationship to a horizon, projection angle, or any combination thereof.

At block 225, the embodiment determines, with respect to the untextured model and using the extracted line features, the orientation of the camera in 3 Degrees of Freedom (3DOF). Determining orientation of the camera may include enforcing some of the extracted line features to be vertical and other extracted line features to be horizontal with respect to the untextured model.

At block 230, the embodiment determines, in response to determining the orientation of the camera, a translation in 3DOF with respect to the untextured model and using the extracted line features. In one embodiment, determining translation (e.g., 3DOF position) of the camera includes establishing correspondences between the extracted line features and model points included in the untextured model. For example, the model points may be any point lying on a vertical model line and also a 2D point on the (x,y) plane). In some embodiments, ZBMI determines orientation and translation of the camera with respect to the untextured model using line features extracted from the single input image, starting from a coarse initial pose estimate that is obtained from device sensors. For example, the sensors may include a satellite positioning system, accelerometer, magnetometer, gyroscope, or any combination thereof. In some embodiments, determining translation includes generating a set of translation hypotheses from the extracted line features and model points included in the untextured model, verifying the set of translation hypotheses by scoring each match between a semantic segmentation of the single image of an urban outdoor scene and a reprojection of the untextured model, and providing the translation with a best match score.

At block 235, the embodiment initializes the 3D map based on the determined orientation and translation. For example, the result of the orientation and translation may be a 6DOF pose matrix. A 6DOF pose matrix may be used to seed/initialize a SLAM system or other tracking and mapping system. The 6DOF pose matrix may also be simply referred to as a refined pose or refined output pose.

In some embodiments, ZBMI determines position of the camera by establishing correspondences between the extracted vertical line features and model façade outlines/model points (e.g., any point on a building façade outline, can be the 2D model point on the (x,y) plane) included in the untextured model. ZBMI can generate a sparse set of pose hypotheses, combining the orientation result with 3D position hypothesis, from assumed correspondences between potential vertical façade outlines detected in the image and vertical façade outlines retrieved from the untextured model. ZBMI can also verify the set of pose hypothesis with an objective function that scores the match between a semantic segmentation of the input image and the reprojection of the 2.5D untextured model. ZBMI may return the pose hypothesis yielding the best match (i.e., highest score) as the final refined 6D camera pose. The final refined 6D camera pose may be used to initialize a SLAM or other mapping system.

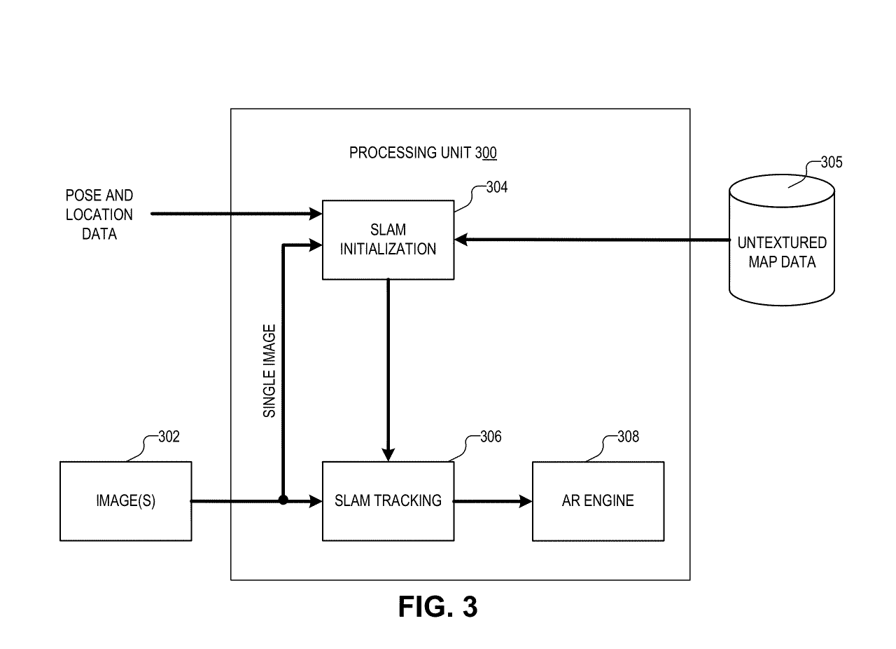

FIG. 3 is a functional block diagram of a processing unit for the 3D map initialization process 200 of FIG. 2. Thus, in one embodiment, processing unit 300, under direction of program code, may perform process 200, discussed above. For example, a temporal sequence of images 302 are received by the processing unit 300, where only a single image (e.g., first keyframe) is passed on to SLAM initialization block 304. In other embodiments, the SLAM initialization may be another 3D map initialization process. Also provided to the SLAM initialization block 304 are pose and location data, as well as untextured map data 305. As mentioned above, the pose and position data may be acquired from SPS, magnetometer, gyroscope, accelerometer, or other sensor of the mobile device from which the single image was acquired. The SLAM initialization block 304 then extracts line features from the single image and aligns the image with the model represented by the untextured map data. The aligned image and pose and location data are then used by SLAM initialization block 304 to initialize SLAM tracking 306 (or other 3D map tracking system), which may immediately then begin tracking pose of the camera. Various augmented reality functions may then be performed by AR engine 308 using the pose information provided by block 306.

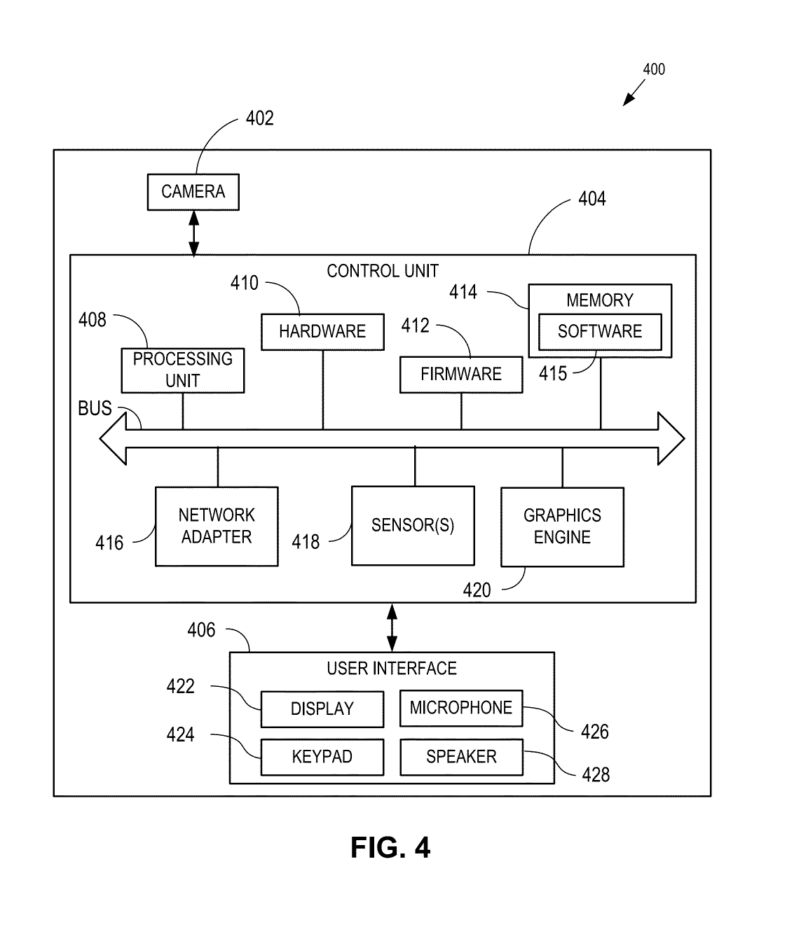

FIG. 4 is a functional block diagram of a mobile device 400 capable of performing the processes discussed herein. For example, mobile device 400 may represent a detailed functional block diagram for the above described mobile device 106. As used herein, a mobile device 400 refers to a device such as a cellular or other wireless communication device, personal communication system (PCS) device, personal navigation device (PND), Personal Information Manager (PIM), Personal Digital Assistant (PDA), laptop or other suitable mobile device which is capable of receiving wireless communication and/or navigation signals, such as navigation positioning signals. The term “mobile device” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile device” is intended to include all devices, including wireless communication devices, computers, laptops, etc. which are capable of communication with a server, such as via the Internet, WiFi, or other network, and regardless of whether satellite signal reception, assistance data reception, and/or position-related processing occurs at the device, at a server, or at another device associated with the network. In addition a “mobile device” may also include all electronic devices which are capable of augmented reality (AR), virtual reality (VR), and/or mixed reality (MR) applications. Any operable combination of the above are also considered a “mobile device.”

Mobile device 400 may optionally include a camera 402 as well as an optional user interface 406 that includes the display 422 capable of displaying images captured by the camera 402. User interface 406 may also include a keypad 424 or other input device through which the user can input information into the mobile device 400. If desired, the keypad 424 may be obviated by integrating a virtual keypad into the display 422 with a touch sensor. User interface 406 may also include a microphone 426 and speaker 428.

Mobile device 400 also includes a control unit 404 that is connected to and communicates with the camera 402 and user interface 406, if present. The control unit 404 accepts and processes images received from the camera 402 and/or from network adapter 416. Control unit 404 may be provided by a processing unit 408 and associated memory 414, hardware 410, software 415, and firmware 412. For example, memory 414 may store instructions for processing the method described in FIG. 2 above.

Processing unit 300 of FIG. 3 is a possible implementation of processing unit 408 for 3D map initialization, tracking, and AR functions, as discussed above. Control unit 404 may further include a graphics engine 420, which may be, e.g., a gaming engine, to render desired data in the display 422, if desired. Processing unit 408 and graphics engine 420 are illustrated separately for clarity, but may be a single unit and/or implemented in the processing unit 408 based on instructions in the software 415 which is run in the processing unit 408. Processing unit 408, as well as the graphics engine 420 can, but need not necessarily include, one or more microprocessors, embedded processors, controllers, application specific integrated circuits (ASICs), digital signal processors (DSPs), and the like. In some embodiments, control unit 404 may further include sensor(s) 418 (e.g., device sensors), which may include a magnetometer, gyroscope, accelerometer, light sensor, satellite positioning system, and other sensor types or receivers. The terms processor and processing unit describes the functions implemented by the system rather than specific hardware. Moreover, as used herein the term “memory” refers to any type of computer storage medium, including long term, short term, or other memory associated with mobile device 400, and is not to be limited to any particular type of memory or number of memories, or type of media upon which memory is stored.

The processes described herein may be implemented by various means depending upon the application. For example, these processes may be implemented in hardware 410, firmware 412, software 415, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the processes may be implemented with modules (e.g., procedures, functions, and so on) that perform the functions described herein. Any non-transitory computer-readable medium tangibly embodying instructions may be used in implementing the processes described herein. For example, program code may be stored in memory 414 and executed by the processing unit 408. Memory may be implemented within or external to the processing unit 408.

If implemented in firmware and/or software, the functions may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, Flash Memory, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

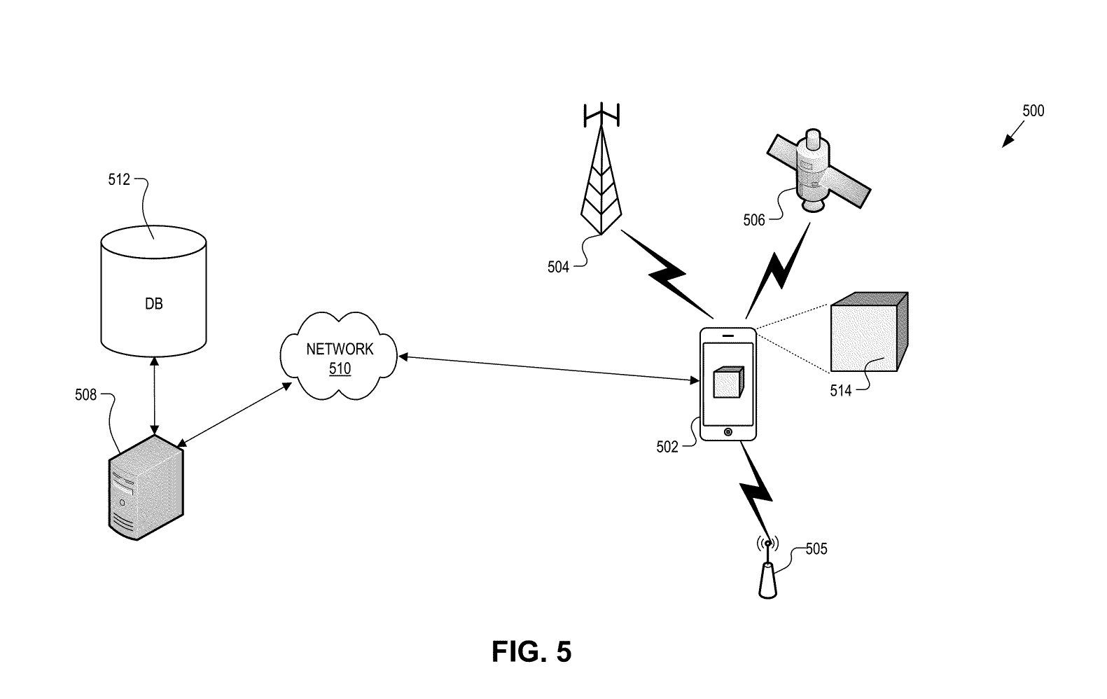

FIG. 5 is a functional block diagram of an image processing system 500. As shown, scene system 500 includes an example mobile device 502 that includes a camera (not shown in current view) capable of capturing images of a scene including object/environment 514. Database 512 may include data, including environment (online) and target (offline) map data.

The mobile device 502 may include a display to show images captured by the camera. The mobile device 502 may also be used for navigation based on, e.g., determining its latitude and longitude using signals from a satellite positioning system (SPS), which includes satellite vehicle(s) 506, or any other appropriate source for determining position including cellular tower(s) 504 or wireless communication access points 705. The mobile device 502 may also include orientation sensors, such as a digital compass, accelerometers or gyroscopes, that can be used to determine the orientation of the mobile device 502.

A SPS typically includes a system of transmitters positioned to enable entities to determine their location on or above the Earth based, at least in part, on signals received from the transmitters. Such a transmitter typically transmits a signal marked with a repeating pseudo-random noise (PN) code of a set number of chips and may be located on ground based control stations, user equipment and/or space vehicles. In a particular example, such transmitters may be located on Earth orbiting satellite vehicles (SVs) 506. For example, a SV in a constellation of Global Navigation Satellite System (GNSS) such as Global Positioning System (GPS), Galileo, Glonass or Compass may transmit a signal marked with a PN code that is distinguishable from PN codes transmitted by other SVs in the constellation (e.g., using different PN codes for each satellite as in GPS or using the same code on different frequencies as in Glonass).

In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

The mobile device 502 is not limited to use with an SPS for position determination, as position determination techniques may be implemented in conjunction with various wireless communication networks, including cellular towers 504 and from wireless communication access points 505, such as a wireless wide area network (WWAN), a wireless local area network (WLAN), a wireless personal area network (WPAN). Further the mobile device 502 may access one or more servers 508 to obtain data, such as online and/or offline map data from a database 512, using various wireless communication networks via cellular towers 504 and from wireless communication access points 505, or using satellite vehicles 506 if desired. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN.

As shown in FIG. 5, system 500 includes mobile device 502 capturing an image of object/scene 514 to initialize a 3D map. As illustrated, the mobile device 502 may access a network 510, such as a wireless wide area network (WWAN), e.g., via cellular tower 504 or wireless communication access point 505, which is coupled to a server 508, which is connected to database 512 that stores information related to target objects and may also include untextured models of a geographic area as discussed above with reference to process 200. While FIG. 5 shows one server 508, it should be understood that multiple servers may be used, as well as multiple databases 512. Mobile device 502 may perform the object tracking itself, as illustrated in FIG. 5, by obtaining at least a portion of the database 512 from server 508 and storing the downloaded map data in a local database inside the mobile device 502. The portion of a database obtained from server 508 may be based on the mobile device's geographic location as determined by the mobile device's positioning system. Moreover, the portion of the database obtained from server 508 may depend upon the particular application that requires the database on the mobile device 502. By downloading a small portion of the database 512 based on the mobile device's geographic location and performing the object detection on the mobile device 502, network latency issues may be avoided and the over the air (OTA) bandwidth usage is reduced along with memory requirements on the client (i.e., mobile device) side. If desired, however, the object detection and tracking may be performed by the server 508 (or other server), where either the query image itself or the extracted features from the query image are provided to the server 508 by the mobile device 502. In one embodiment, online map data is stored locally by mobile device 502, while offline map data is stored in the cloud in database 512.

The order in which some or all of the process blocks appear in each process discussed above should not be deemed limiting. Rather, one of ordinary skill in the art having the benefit of the present disclosure will understand that some of the process blocks may be executed in a variety of orders not illustrated.

Those of skill would further appreciate that the various illustrative logical blocks, modules, engines, circuits, and algorithm steps described in connection with the embodiments disclosed herein may be implemented as electronic hardware, computer software, or combinations of both. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Various modifications to the embodiments disclosed herein will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A computer-implemented method of initializing a 3-Dimensional (3D) map, the method comprising:
obtaining, from a camera, a single image of an urban outdoor scene;
estimating, from one or more device sensors, an initial pose of the camera;
obtaining, based at least in part on the estimated initial pose, an untextured model of a geographic region that includes the urban outdoor scene;
extracting a plurality of line features from the single image;
determining, with respect to the untextured model and using the extracted line features, the orientation of the camera in 3 Degrees of Freedom (3DOF);
determining, in response to determining the orientation of the camera, a translation in 3DOF with respect to the untextured model and using the extracted line features; and
initializing the 3D map based on the determined orientation and translation.

2. The computer-implemented method of claim 1, wherein the one or more device sensors include: a satellite positioning system, accelerometer, magnetometer, gyroscope, or any combination thereof.

3. The computer-implemented method of claim 1, wherein the untextured model includes a 2.5D topographical map with building height data.

4. The computer-implemented method of claim 1, wherein determining orientation of the camera includes enforcing some of the extracted line features to be vertical and other extracted line features to be horizontal with respect to the untextured model.

5. The computer-implemented method of claim 1, further comprising:
filtering the extracted line features according to one or more of: length, relationship to a horizon, projection angle, or any combination thereof.

6. The computer-implemented method of claim 1, wherein determining the translation further comprises:
generating a set of translation hypotheses from the extracted line features and model points included in the untextured model;
verifying the set of translation hypotheses by scoring each match between a semantic segmentation of the single image of the urban outdoor scene and a reprojection of the untextured model; and
providing the translation with a best match score.

7. The computer-implemented method of claim 6, wherein the extracted line features are vertical line features, and wherein the model points include model façade outlines.

8. A computer-readable medium including program code stored thereon for initializing a 3-Dimensional (3D) map, the program code comprising instructions to:
obtain, from a camera, a single image of an urban outdoor scene;
estimate, from one or more device sensors, an initial pose of the camera;
obtain, based at least in part on the estimated initial pose, an untextured model of a geographic region that includes the urban outdoor scene;
extract a plurality of line features from the single image;
determine, with respect to the untextured model and using the extracted line features, the orientation of the camera in 3 Degrees of Freedom (3DOF);
determine, in response to determining the orientation of the camera, a translation in 3DOF with respect to the untextured model and using the extracted line features; and
initialize the 3D map based on the determined orientation and translation.

9. The computer-readable medium of claim 8, wherein the one or more device sensors include: a satellite positioning system, accelerometer, magnetometer, gyroscope, or any combination thereof.

10. The computer-readable medium of claim 8, wherein the untextured model includes a 2.5D topographical map with building height data.

11. The computer-readable medium of claim 8, wherein the instructions to determine orientation of the camera includes instructs to enforce some of the extracted line features to be vertical and other extracted line features to be horizontal with respect to the untextured model.

12. The computer-readable medium of claim 8, further comprising instructions to:
filter the extracted line features according to one or more of: length, relationship to a horizon, projection angle, or any combination thereof.

13. The computer-readable medium of claim 8, wherein determining the translation further comprises instructions to:
generate a set of translation hypotheses from the extracted line features and model points included in the untextured model;
verify the set of translation hypotheses by scoring each match between a semantic segmentation of the single image of the urban outdoor scene and a reprojection of the untextured model; and
provide the translation with a best match score.

14. The computer-readable medium of claim 13, wherein the extracted line features are vertical line features, and wherein the model points include model façade outlines.

15. An mobile device, comprising:
memory adapted to store program code for initializing a 3-Dimensional (3D) map;
a camera;
a processing unit configured to access and execute instructions included in the program code, wherein when the instructions are executed by the processing unit, the processing unit directs the mobile device to:
obtain, from a camera, a single image of an urban outdoor scene;
estimate, from one or more device sensors, an initial pose of the camera;
obtain, based at least in part on the estimated initial pose, an untextured model of a geographic region that includes the urban outdoor scene;
extract a plurality of line features from the single image;
determine, with respect to the untextured model and using the extracted line features, the orientation of the camera in 3 Degrees of Freedom (3DOF);
determine, in response to determining the orientation of the camera, a translation in 3DOF with respect to the untextured model and using the extracted line features; and
initialize the 3D map based on the determined orientation and translation.

16. The mobile device of claim 15, wherein the one or more device sensors include: a satellite positioning system, accelerometer, magnetometer, gyroscope, or any combination thereof.

17. The mobile device of claim 15, wherein the untextured model includes a 2.5D topographical map with building height data.

18. The mobile device of claim 15, wherein the processor further comprises instructions to determine orientation of the camera includes instructs to enforce some of the extracted line features to be vertical and other extracted line features to be horizontal with respect to the untextured model.

19. The mobile device of claim 15, wherein the processor further comprises instructions to:
filter the extracted line features according to one or more of: length, relationship to a horizon, projection angle, or any combination thereof.

20. The mobile device of claim 15, wherein determining the translation further comprises instructions to:
generate a set of translation hypotheses from the extracted line features and model points included in the untextured model;
verify the set of translation hypotheses by scoring each match between a semantic segmentation of the single image of the urban outdoor scene and a reprojection of the untextured model; and
provide the translation with a best match score.

21. The mobile device of claim 20, wherein the extracted line features are vertical line features, and wherein the model points include model façade outlines.

22. An apparatus, comprising:
means for obtaining, from a camera, a single image of an urban outdoor scene;
means for estimating, from one or more device sensors, an initial pose of the camera;
means for obtaining, based at least in part on the estimated initial pose, an untextured model of a geographic region that includes the urban outdoor scene;
means for extracting a plurality of line features from the single image;
means for determining, with respect to the untextured model and using the extracted line features, the orientation of the camera in 3 Degrees of Freedom (3DOF);
means for determining, in response to determining the orientation of the camera, a translation in 3DOF with respect to the untextured model and using the extracted line features; and
means for initializing the 3D map based on the determined orientation and translation.

23. The apparatus of claim 22, wherein the one or more device sensors include: a satellite positioning system, accelerometer, magnetometer, gyroscope, or any combination thereof.

24. The apparatus of claim 22, wherein the untextured model includes a 2.5D topographical map with building height data.

25. The apparatus of claim 22, wherein the means for determining orientation of the camera includes means for enforcing some of the extracted line features to be vertical and other extracted line features to be horizontal with respect to the untextured model.

26. The apparatus of claim 22, further comprising:
means for filtering the extracted line features according to one or more of: length, relationship to a horizon, projection angle, or any combination thereof.

27. The apparatus of claim 22, wherein the means for determining the translation further comprises:
means for generating a set of translation hypotheses from the extracted line features and model points included in the untextured model;
means for verifying the set of translation hypotheses by scoring each match between a semantic segmentation of the single image of the urban outdoor scene and a reprojection of the untextured model; and
means for providing the translation with a best match score.

28. The apparatus of claim 27, wherein the extracted line features are vertical line features, and wherein the model points include model façade outlines.
